(19) United States
(12) Patent Application Publication
(10) Pub. No.: US 2002/0113391 A1
(43) Pub. Date: Aug. 22, 2002

(54) Simplified geared scooter

(76) Inventors: Leao Wang, Taiping (TW); Peter Wu, Taiping (TW)

Correspondence Address: BRUCE H. TROXELL, 5205 LEESBURGE PIKE, SUITE 1404, FALLS CHURCH, VA, 22041, US

(21) Appl. No.: 09/788,730

(22) Filed: Feb. 20, 2001

(51) Int. Cl. B62M 1/00

(52) U.S. Cl. 280/87.05

(57) ABSTRACT

The present invention relates to a simplified geared scooter which includes deck assembly, a handlebar, a front wheel assembly and a rear wheel assembly. One end of the handlebar penetrates through the deck assembly and is pivotably connected to one end of the coupling mechanism. The coupling mechanism includes a pivoting shaft and a drive element while a resilient member is formed at one end of the drive element. After the drive element is circled in an engaging way around a one-way drive mechanism on the rear wheel assembly, the resilient member is fixed at a proper position of the deck assembly. Accordingly, when the deck assembly is moved with to-and-fro motion, the coupling mechanism is movable therewith so that the one-way drive mechanism is driven by the coupling mechanism to bring the rear wheel assembly in motion, and the scooter is therefore moved forward.

### BACKGROUND OF THE INVENTION

1. Field of the Invention

The present invention relates to a geared scooter, and more particularly to a scooter which can be moved forward by swinging a handlebar in a simplified way.

2. Description of the Prior Art

The scooter is a very popular sporting device. A conventional scooter, as shown in FIG. 3, includes a front wheel assembly, a rear wheel assembly and a handlebar assembly. The forward movement thereof completely depends upon the continuous contact of one foot of the user with the ground. This design is perfect for the purpose of exercise. However, it will be too impractical and monotone in consideration of the space factor and the exercise fun. If the space is limited, there will be trouble and inconvenience for the foot to contact with the ground, or the user has no choice but to stop it. Moreover, the workout way of all scooters on the market is the same. Accordingly, the workout fun thereof is decreased degree by degree.

### SUMMARY OF THE INVENTION

It is a primary object of the present invention to eliminate the drawbacks associated with the prior art and to provide a geared scooter that allows the user to swing the handlebar for forward movement and, therefore, to have an additional workout fun in riding it.

### BRIEF DESCRIPTION OF THE DRAWINGS

The accomplishment of this and other objects of the invention will become apparent from the following description and its accompanying drawings of which:

FIG. 1 is a perspective assembly view of the present invention;

FIG. 2 is a schematic drawing of the swinging action of the present invention; and

FIG. 3 is a perspective view of the prior art.

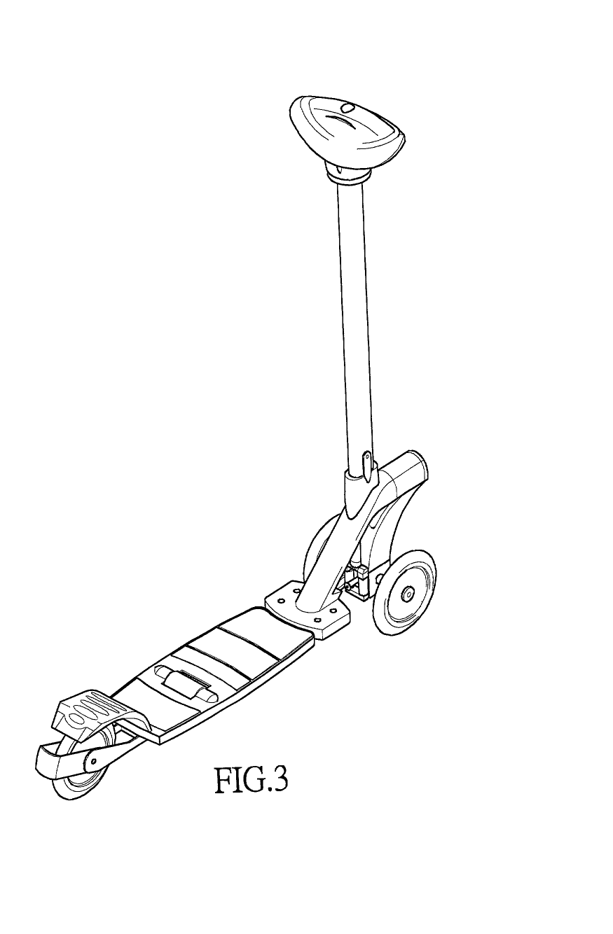

### DETAILED DESCRIPTION OF THE PREFERRED EMBODIMENT

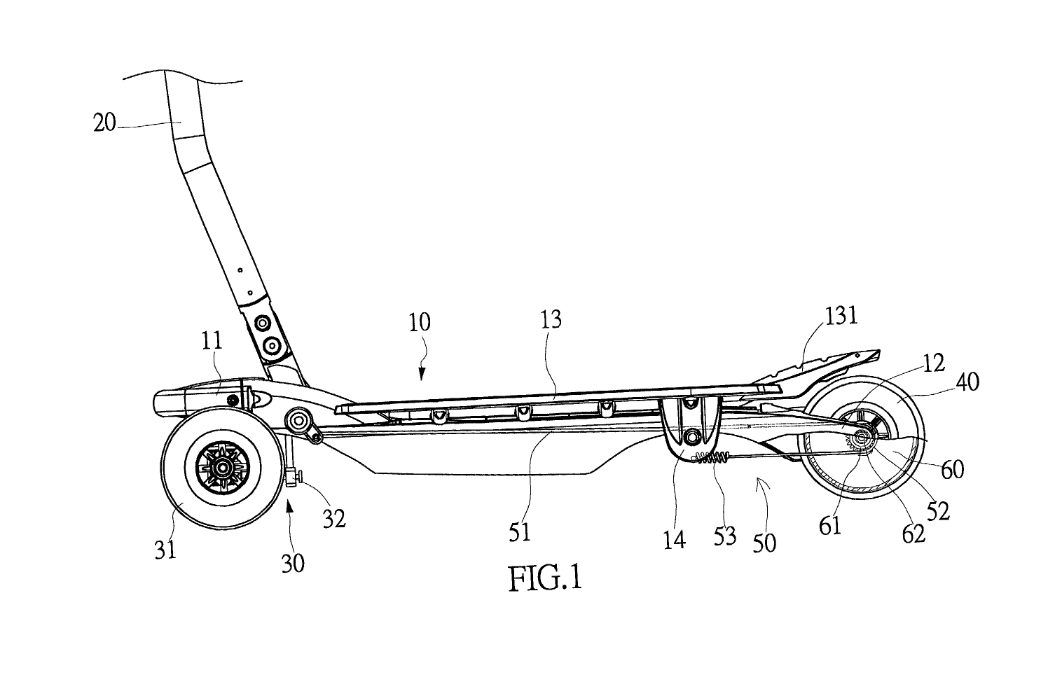

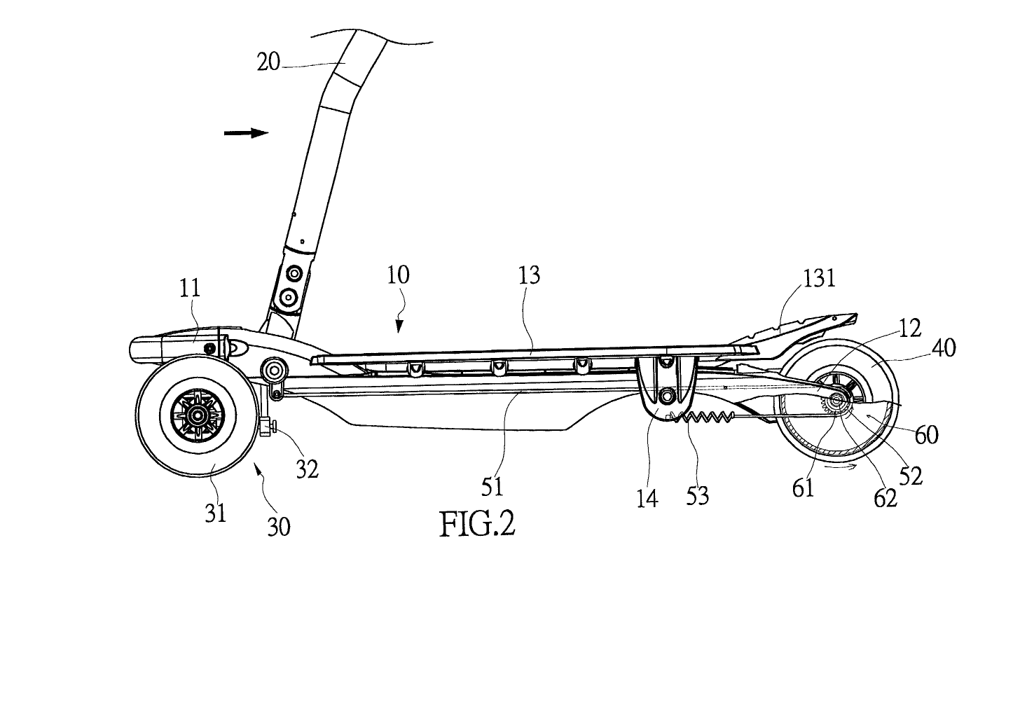

Referring to FIGS. 1 and 2, the geared scooter in accordance with the present invention includes a deck assembly 10 on which a handlebar 20, a :front wheel assembly 30, a rear wheel assembly 40, a coupling mechanism 50 and a one-way drive mechanism 60 are mounted.

The deck assembly 10 includes a front swivel member 11, a rear swivel member 12 and a deck 13. An arched swivel fender 131 disposed at rear end of the deck 13 and used for braking is located above the rear wheel assembly 40.

The handlebar 20 is an elongated bar for holding and swinging. Two grips 21 are formed at the top end thereof, extending from either side of the center stem while the other end thereof penetrates through the deck assembly 10 and is pivotably connected in a swinging way.

The front wheel assembly 30 has two movable wheels 31 and is pivotably connected at the front swivel member 11. Meanwhile, a steering assembly 32 works together with the deck assembly 10 and the handlebar 20 in order that the front wheel assembly 30 steers the scooter to the right or to the left. This mechanism has been disclosed by the inventor of the present invention in prior art so that no further descriptions are given hereinafter.

The rear wheel assembly 40 is arranged at the rear swivel member 12 of the deck assembly 10. A one-way drive mechanism 60 is pivotably connected to the rear wheel assembly 40.

The coupling mechanism 50 is composed of a pivoting shaft 51 and a drive element 52. One end of the pivoting shaft 51 is joined to the handlebar 20 while the other end thereof is connected to the drive element 52. The drive element 52 is a transmission chain or another equivalent object. A resilient member 53 is formed at the other end thereof. The resilient member 53 is used to return the handlebar 20 in position. The drive element 52 is disposed around the one-way drive mechanism 60 on the rear wheel assembly 40. After the drive element 52 is engaged with the one-way drive mechanism 60, the resilient member 53 is fastened at a fixing plate 14 of the deck assembly 10.

The one-way drive mechanism 60 consists of a gear 61 and a one-way drive element 62. The one-way drive element 62 is pivotably connected with the gear 61 and the rear wheel assembly 40 while the rear wheel assembly 40 is made to rotate unidirectionally.

By means of the aforementioned elements, the user can swing the handlebar 20 to and fro for creating a rolling power in riding the scooter by means that the coupling mechanism 50 brings the one-way drive mechanism 60 in motion. Thereafter, the rear wheel assembly 40 is rotated to drive the scooter for a continuous movement, as shown in FIG. 2. In addition, the rear wheel assembly 40 is pivotably connected to the one-way drive element 62 and the gear 61 in a body so that the scooter can be unidirectionally driven forward.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A scooter with a simplified geared mechanism which is driven by a handlebar working with a coupling mechanism for driving a one-way drive mechanism to allow wheels thereof to make a forward movement.

2. A simplified geared scooter comprising a deck assembly, a handlebar, a front wheel assembly and a rear wheel assembly,
wherein said deck assembly includes a deck, and said front wheel assembly and said rear wheel assembly are arranged at front and rear ends of said deck assembly, and said handlebar is pivotably disposed at the front end of said deck assembly; and
wherein one end of said handlebar penetrates through said deck assembly and is pivotably connected to one end of said coupling mechanism, and said coupling mechanism includes a pivoting shaft and a drive element while a resilient member is formed at one end of said drive element, and after said drive element is circled in an engaging way around a one-way drive mechanism on said rear wheel assembly, said resilient member is fixed at a proper position of said deck assembly; accordingly, when said deck assembly is moved with to-and-fro motion, said coupling mechanism is movable therewith so that said one-way drive mechanism is driven by said coupling mechanism to bring said rear wheel assembly in motion, and the scooter is therefore moved forward.

3. A simplified geared scooter as claimed in claims 1 and 2, wherein said one-way drive mechanism includes a gear and a one-way drive element, and said one-way drive element is pivotably connected with said gear and said rear wheel assembly while said rear wheel assembly is made to rotate unidirectionally.
